(19) United States
(12) Patent Application Publication
(10) Pub. No.: US 2014/0247208 A1
(43) Pub. Date: Sep. 4, 2014

(54) INVOKING AND WAKING A COMPUTING DEVICE FROM STAND-BY MODE BASED ON GAZE DETECTION

(71) Applicant: Tobii Technology AB, Danderyd (SE)

(72) Inventors: David Henderek, Stockholm (SE); Mårten Skogö, Stockholm (SE); John Elvesjö, Stockholm (SE)

(73) Assignee: Tobii Technology AB, Danderyd (SE)

(21) Appl. No.: 13/894,424

(22) Filed: May 14, 2013

Related U.S. Application Data
(60) Provisional application No. 61/771,659, filed on Mar. 1, 2013.

(51) Int. Cl. G06F 1/32; G06F 3/0487; G06F 3/0482; G06F 3/01; G06F 3/0481

(52) U.S. Cl. CPC G06F 1/3296; G06F 3/013; G06F 3/04817; G06F 3/0482; G06F 3/0487
USPC 345/156

(57) ABSTRACT

Waking a computing device from a stand-by mode may include determining a wake zone relative to a display device and, when the computing device is in stand-by mode, detecting a gaze point relative to the display device. In response to determining that the gaze point is within the wake zone, a wake command is generated and passed to a program module, such as the operating system, to cause the program module to wake the computing device from the stand-by mode. When the computing device is not in stand-by mode, another gaze point may be detected and, in response to determining that the other gaze point is within the vicinity of a selectable stand-by icon, the stand-by command is generated and passed to the program module to cause the program module to place the computing device into the stand-by mode.

### CROSS-REFERENCE TO RELATED APPLICATION

This application claims priority, to U.S. Provisional Patent Application No. 61/771,659 filed Mar. 1, 2013, entitled “User Interaction Based On Intent,” which is incorporated herein in its entirety by this reference.

### BACKGROUND

Human computer interaction generally relates to the input of information, and control of, a computer by a user. Traditionally this interaction is performed via methods such as typing on a keyboard, using a computer mouse to select items or in some cases the use of a touch sensitive pad commonly referred to as a “trackpad” or the like. Recently, new forms of user interaction have been developed that allow both simple and complex forms of human computer interaction. An example of this is touch based interaction on a computer, tablet, phone or other computing device, whereby a user interacts with the device by touching the screen and performing gestures such as “swiping”, “pinch-to-zoom” and the like. These forms of user interaction require a physical connection between the device and the user, as they centrally revolve around contact of some form. Therefore non-contact interaction methods have been previously proposed. These non-contact methods include voice control, eye or face tracking and non-contact gestures.

Gaze detection relates to the monitoring or tracking of eye movements to detect a person's gaze point. Various types of gaze detection systems and methods are known. For example products sold by Tobii Technology AB operate by directing near infrared illumination towards a user's eye and detecting reflection of the infrared illumination from the user's eye using an image sensor. Based on the location of the reflection on the eye, a processing device can calculate the direction of the user's gaze. Such a gaze detection system is described in U.S. Pat. No. 7,572,008. Other alternative gaze detection systems are also known, such as those disclosed in U.S. Pat. No. 6,873,314 and U.S. Pat. No. 5,471,542.

A gaze detection system can be employed as a user input mechanism for a computing device, using gaze detection to generate control commands. Eye control can be applied as a sole interaction technique or combined with other control commands input via keyboard, mouse, physical buttons and/or voice. It is now feasable to add gaze detection technology to many mobile computing devices, smart phones and tablet computers, and personal computers. Most standard-type web cameras and cameras integrated into mobile computing devices have a resolution of a few million pixels, which provides sufficient optical quality for eye-tracking purposes. Most mobile computing devices and personal computers also have sufficient processing power and memory resources for executing gaze detection software.

A problem develops, however, when using gaze detection systems and other non-contact interaction methods, in that they tend to lack the clear definition and identification of user input commands as provided by contact interaction methods. Therefore it can sometimes be ambiguous as to the intention of a non-contact input command. Further, many common and popular computer programs or operating systems have been developed to function primarily with contact input methods. This presents a problem for people who desire to use non-contact input methods, which may be a necessity for many reasons such as a lack of ability to use a contact method through injury or disability.

There therefore exists a need to develop input methods and interaction components and systems for computing devices that can encompass a wide variety of input methods, and can function effectively on computing devices developed for use primarily with contact input methods. There is also a need for more simplistic input methods for controlling important functions of a computing device, such as power-saving functions, which provides greater ease of use and added convenience for the user, particularly in portable computing devices.

### SUMMARY OF THE INVENTION

The following systems and methods provide solutions for automatically waking a computing device from a stand-by mode in response to gaze detection. As used herein the term “stand-by mode” is generally meant to include any non-interactive or power-saving mode or state for a computing device, including “sleep mode,” hibernate mode,” “screen-saver mode,” “power-saver mode” and the like. When the computing device is “awake” (i.e., not in stand-by mode), content and various selectable icons, menus and other input control items may be displayed in a window rendered on a display screen. In some embodiments, gaze detection or other user interaction with such input control items or physical controls (e.g., button or switch, etc.) may be employed to force the computing device into stand-by mode. In one example, a “menu zone” may be defined relative to a particular location on the display screen. Detecting a gaze point within the menu zone may trigger the display of a menu that includes an icon for invoking a stand-by mode for the computing device. The computing devices may also be configured to automatically invoke stand-by mode in certain circumstances, such as following a predefined period of non-use or upon detecting that expected battery life has fallen below a predefined threshold, etc.

Gaze detection components may be added to or used with the computing device to detect that a user is gazing at or near the display screen. The gaze detection components include hardware and software elements for determining a gaze point relative to the display screen. In some cases, images of at least one facial feature of the user may be captured, such as at least one of a nose, a mouth, a distance between two eyes, a head pose and a chin, and at least one facial feature may be used in determining the gaze point.

The computing device may be configured such the gaze detection components remain active, at least intermittently (e.g., activated and deactivated in a sequence that may approximated by a sine wave or any other patterned or random sequence), when the computing device enters stand-by mode. In this way the computing device continues to monitor for user gaze and calculating gaze points while in stand-by mode. At least one “wake zone” may be defined relative to the display screen. This wake zone may be predetermined and/or may be defined by the user. In response to determining that the gaze point is within a wake zone, a “wake” command is initiated, which causes the computing device to perform a routine for exiting stand-by mode.

In some instances, statistical analysis may be applied to gaze data patterns to determine that the gaze point is within the wake zone. A wake zone may be defined as an area of the display screen, such as an area adjacent to the top, bottom or one of the sides of the display screen. In other cases, a wake zone may be defined as an area away from the display screen. Any location within the field of view of the gaze detection components may be defined and used as a wake zone. In some embodiments, a gaze point must be detected and remain in a wake zone for a defined duration of time before the wake command it initiated.

Additional features, advantages, and embodiments may be set forth in or apparent from consideration of the following detailed description, drawings, and claims. Moreover, it is to be understood that both the foregoing summary and the following detailed description are provided by way of example only and intended to provide further explanation without limiting the scope of the claimed subject matter.

### BRIEF DESCRIPTION OF THE DRAWINGS

Many aspects of the present disclosure can be better understood with reference to the following diagrams. The drawings are not necessarily to scale, emphasis instead being placed upon clearly illustrating certain features of the disclosure. Moreover, in the drawings, like reference numerals designate corresponding parts throughout the several views.

FIG. 1 is a block diagram illustrating an example of computing device configured for executing a gaze detection program module in accordance with some embodiments of the present invention.

FIG. 2 shows an example of a user interface of an exemplary computing device configured for executing a gaze detection program module for invoking a stand-by mode, in accordance with some embodiments of the present invention.

FIG. 3 shows another view of the exemplary user interface of FIG. 2, displaying a menu that includes a selectable icon for invoking the stand-by mode.

FIG. 4 is a flowchart illustrating an example of a method for invoking a stand-by mode for a computing device based on gaze detection, in accordance with certain embodiments of the present invention.

FIG. 4 shows an example of computing device configured for executing a gaze detection program module for waking the computing device from a stand-by mode in accordance with some embodiments of the present invention.

FIG. 6 is a flowchart illustrating an example of a method for waking a computing device from a stand-by mode, in accordance with certain embodiments of the present invention.

### DETAILED DESCRIPTION

It is to be understood that the subject matter disclosed and claimed herein is not limited to the particular methodology, protocols, etc. described herein, as the skilled artisan will recognize that these may vary in different embodiments. The embodiments disclosed herein and the various features and advantageous details thereof are explained more fully with reference to the non-limiting embodiments and examples that are illustrated in the accompanying drawings and detailed in the following description. Descriptions of well-known components and computing techniques may be omitted so as to not unnecessarily obscure the described embodiments. The examples used herein are intended merely to facilitate an understanding of ways in which the subject matter disclosed and claimed herein may be practiced and to further enable those of skill in the art to practice various embodiments.

Disclosed are various embodiments of systems and associated devices and methods for implementing a function for waking a computing device from a stand-by mode based on gaze detection. Gaze detection is also sometimes referred to as eye-tracking. As will be appreciated, gaze detection systems include hardware and software components for detecting eye movements, generating data representing such eye movements, and processing such data to determine a gaze point relative to a display screen or other object. By way of example, a gaze point can be expressed in terms of coordinates in a coordinate system.

Certain embodiments of the present invention are described herein with respect to camera-based gaze detection systems, but it should be understood that the invention is also applicable to any available or later-developed gaze detection systems. For example, embodiments of the invention may rely on gaze detection system that employ infrared-sensitive image sensors and collimated infrared sources to determine gaze points. Other embodiments may rely additionally or alternatively on face or body position tracking devices or other systems that enable at least directional input into a computing device that can be used to control the device. Embodiments of the present invention have particular application in mobile computing devices, such as mobile phones, smart phones, tablet computers, e-readers, personal digital assistants, personal gaming devices, media players and other handheld or laptop computer devices. In other embodiments, the invention may be used with other computing devices, including desktop computers, mainframe personal computers, set top boxes, game consoles, and the like. In still other embodiments the invention may be used with computing devices built into or in communication with other devices and appliances (e.g., televisions, projectors, kitchen appliances, such as microwaves, refrigerators, etc., and the like). Installing gaze detection components, which in some cases may include one small camera, an infra-red diode and the appropriate software for implementing embodiments of the invention, into such devices and/or appliances could help to ensure active power savings, turning the device or appliance on and off (or from stand-by mode to/awake mode) by looking at or looking away from certain defined areas or zones relative to the device or appliance.

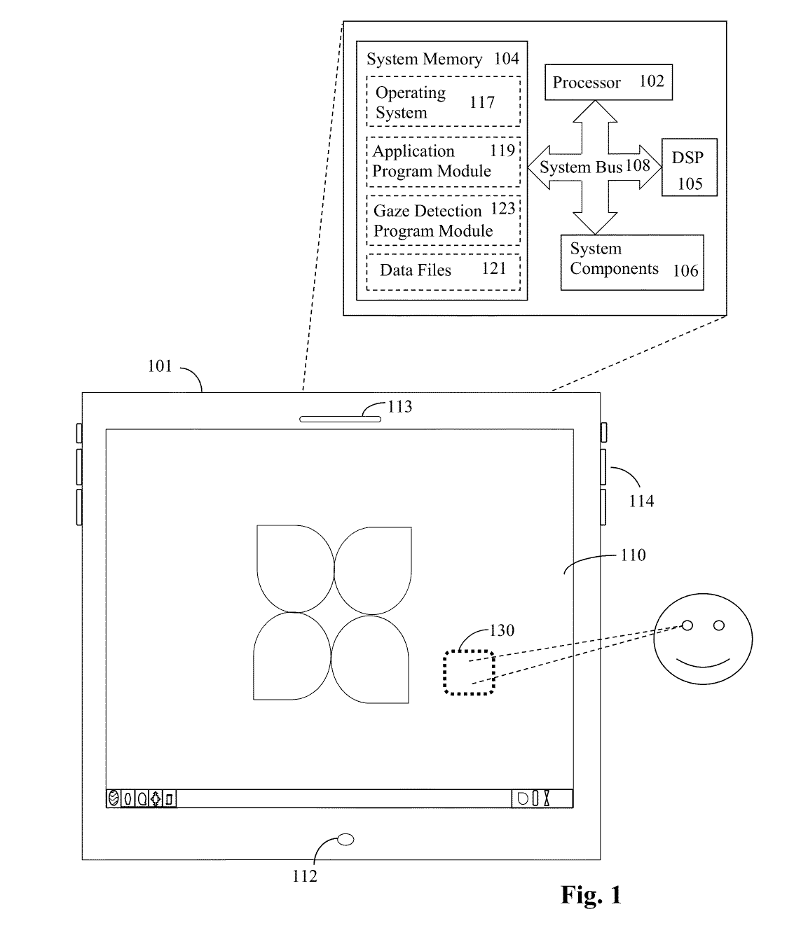

FIG. 1 is a block diagram illustrating an example of computing device 101 used in accordance with some embodiments of the present invention. Typical components of such a computing device 101 include a processor 102, a system memory 104, and various system interface components 106. As used in this discussion, the term “processor” can refer to any type of programmable logic device, including a microprocessor or any other type of similar device. The processor 102, system memory 104 and system interface components 106 may be functionally connected via a system bus 108. The system interface components 106 may enable the processor 102 to communicate with integrated or peripheral components and/or devices, such as a display screen 110 (which may include touch screen capabilities), a camera 112, an input device, such as a control button 114 or physical keyboard, wired and/or wireless communication components, speaker(s) and other output components, etc.

In the embodiment shown, the camera 112 is integrated with the computing device 101. In other embodiments, the camera 112 may be a peripheral or add-on device that is attached to or used in proximity to the computing device 101. In some embodiments, particularly where the computing device 101 is a table computer, smart phone, laptop or other portable device, the camera 112 is positioned below the display screen 110, so that it “looks up” at the user's eyes as the user look down at the display screen 110. In other embodiments the computing device may additionally or alternatively include a web-cam positioned above the display screen 110 or at another suitable position. As is known in the art, such web-cams may be configured to interoperate with gaze detection software to implement gaze detection components or systems.

A camera 112 may be configured for capturing still images and/or video. Images or video captured by the camera 112 may be used for gaze detection, as will be described. One or more illuminator, such as an infrared illuminator, may be positioned in proximity to the camera 112 to enhance performance, as will be described herein. In some embodiments, other gaze detection components may be connected to and/or integrated with the computing device 101 via appropriate system interface components 106.

A number of program modules may be stored in the system memory 104 and/or any other computer-readable media associated with the computing device 101. The program modules may include, among others, an operating system 117, various application program modules 119 and a gaze detection program module 123. In general, and for purposes of the present discussion, an application program module 119 includes computer-executable code (i.e., instructions) for rendering images, text and other content within a window or other portion of the display screen 110 and for receiving and responding to user input commands (e.g., supplied via a gaze detection system, touch screen, camera, keyboard, control button 114, microphone 113, etc.) to manipulate such displayed content. Non-limiting examples of application program modules 119 include browser applications, email applications, messaging applications, calendar applications, e-reader applications, word processing applications, presentation applications, etc.

A gaze detection program module 123 may include computer-executable code for detecting gaze points, saccades and/or other indicators of the user reading rather than gazing (e.g. eye fixation or dwelling on or around a constant point on the display) and other eye tracking data and for calculating positions of gaze points relative to the display screen 110. A gaze detection program module 123 may further include computer-executable code for controlling and receiving signals from a camera 112 or the components of other gaze detection systems. In other words, the gaze detection program module 123 may control the activation/deactivation and any configurable parameters of the camera 112 and may receive signals from the camera 112 representing images or video captured or detected by the camera 112. The gaze detection program module 123 may process such signals so as to determine reflection of light on the cornea or other portion of an eye, pupil location and orientation, pupil size or other metric for determining a location on a screen that is being viewed by an eye and use such information to determine the coordinates of a gaze point 130.

For ease of reference, embodiments of the invention are described herein with respect to a gaze detection program module 123 executed by a computing device 101. As will be appreciated, however, the gaze detection program module 123 described herein (or components thereof) may also or alternatively be stored in a memory of and executed by a stand-alone gaze detection system, such as an “eye tracker,” that may be integrated with or connected to a computing device 101. Such a gaze tracking system may include some or all of the computing components mentioned above, including a processor, memory, and system interface components, which may be functionally connected via a system bus. A gaze detection system may include other integrated or peripheral components and/or devices, such as a camera, one or more illuminator, a display screen and other input devices, wired and/or wireless communication components, various output components, etc. Thus, in some embodiments, a gaze detection system may have processing capabilities and may be configured to calculate gaze point coordinates (e.g., x,y coordinates) and pass them to the computing device 101 via a wired or wireless interface. Alternatively, such a gaze detection system may pass raw gaze data to the computing device 101 for the computing device 101 to process and calculate gaze points.

In some cases, camera based gaze detection components and systems may rely on facial recognition processing to detect facial features such as nose, mouth, distance between the two eyes, head pose, chin etc. Combinations of these facial features may be used to determine the gaze point 130. For instance in some embodiments facial images may be captures by the camera 112 and the detection of the gaze point 130 may rely solely on the detected eyelid position(s). In other words, when the user gazes at the lower portion of the display screen 110, the eye will be detected as being more closed, whereas when the user gazes at the top of the display screen 110, the eye will be detect as being more open.

Eye lid position detection is good for determining changes in gaze points in a vertical direction, but not as effective for determining changes in gaze points in a horizontal direction. For better determining changes in gaze points in a horizontal direction, images of the head pose may be used instead. In such cases, gaze points may be determined based on detecting how the user's face is oriented relative to the general direction of the display screen 110. As general rule, whenever a user looks at an object more than 7 degrees off from his direct forward line of sight, he will immediately turn his head in the direction of that object. Thus a head pose indicating more than 7 degrees off to a side from the display screen 110 is an indication that the user is unlikely to be looking at content displayed on the display screen 110.

As used herein, the term “gaze point” is intended to represent an area or region relative to the display screen 110 to which the user's gaze is directed. Depending on the sensitivity and accuracy of the gaze detection components, which may be dictated by camera resolution, processing power, available memory, and the like, a gaze point 130 may occupy a smaller (more sensitive/accurate) or larger (less sensitive/accurate) area relative to the display screen 110. Calibration of the gaze detection components may also play a role in the accuracy and sensitivity of gaze point calculations. Accuracy or sensitivity may dictate the relationship between an actual gaze point and a projected gaze point. The actual gaze point is the point relative to a display at which the user is actually looking, and the projected gaze point is the point relative to a display that the gaze detection program module 123 determines as the gaze point. One advantage of the present invention is that it functions even if the relationship between the actual and projected gaze points is not direct.

In some embodiments, the actual gaze may be calibrated with the projected gaze point by using touch data, input via a touch screen, to assist with calibration. For example, the gaze detection program module 123 or another process executed on the computing device 101 may be configured for prompting the user to look at and touch the same point(s) on the display screen 110. The detected gaze point will represent the projected gaze point and the detected touch point will represent the actual gaze point. Alternatively, a calibration process may be performed in the background without prompting the user or interrupting the user's normal interaction with the computing device 101. For example, as the user normally operates the computing device 101 he/she will be pressing buttons, hyperlinks, and other portions of displayed content, display screen 110 and/or computing device 101 having known positions. The user will normally also be looking at the buttons, hyperlinks, etc. at the same time. Thus, gaze detection program module 123 or another process may recognize the touch point as the actual gaze point and then correct any discrepancies between the actual gaze point and the projected gaze point. Such a background calibration process can be helpful in order to slowly improve calibration as the user interacts with the computing device over time.

In other embodiments, calibration may be performed solely by gaze detection. For example, a calibration routine may involve displaying in sequence a number (e.g., 6-10) of points or images on the display screen 110 for a short duration (e.g., a few seconds) and comparing detected gaze points to the actual positions of the displayed points or images to adjust the precision and/or accuracy of the gaze point calculations. Other calibration techniques will be apparent to those of skill in the art.

In some embodiments, one or more light sources may be added around, or in proximity to the display screen 110 and/or in proximity to the camera 112 to provide more illumination to an eye, so as to enhance the sensitivity and accuracy of the gaze detection program module 123. Such a light source may be an infrared or other non-visable light source or a visible light source. An example of using light sources to improve the sensitivity of an eye tracking system is shown in U.S. Pat. No. 8,339,446. Further, in some embodiments, illumination found in the user's own environment, so-called ambient illumination, may be used to enhance the sensitivity and accuracy of the gaze detection program module 123. Additionally the light source(s) will cause reflections in the eyes of the user that may be used as one of the features when determining the gaze point 130.

In some embodiments the computing device 101 may include a digital signal processing (DSP) unit 105 for performing some or all of the functionality ascribed to the gaze detection program module 123. As is known in the art, a DSP unit 105 may be configured to perform many types of calculations including filtering, data sampling, triangulation and other calculations with respect to data signals received from an input device such as a camera 112 or other sensor. The DSP unit 105 may include a series of scanning imagers, digital filters, and comparators implemented in software. The DSP unit 105 may therefore be programmed for calculating gaze points 130 relative to the display screen 110, as described herein. A DSP unit 105 may be implemented in hardware and/or software. Those skilled in the art will recognize that one or more graphics processing unit (GPU) may be used in addition to or as an alternative to a DSP unit 105.

In some embodiments, the operating system 117 of a computing device may not provide native support for interpreting gaze detection data into input commands. Therefore, in such cases, the gaze detection program module 123 (or DSP unit 105) may be configured to generate and pass to the operating system 117 or to another program module or process commands that emulate natively supported commands (e.g., a command that would be invoked upon activation of a button, a mouse click or a mouse wheel scroll and/or other contact-based commands).

The gaze detection program module 123 and/or DSP unit 105 and/or one or more GPU in combination with the camera 112 is referred to generally herein as a gaze detection system. As mentioned, other types of gaze detection systems may be connected to and/or integrated with the computing device 101. The processor 102, which may be controlled by the operating system 117, can be configured to execute the computer-executable instructions of the various program modules, including the gaze detection program module 123, an application program module 119 and the operation system 117. The methods of the present invention may be embodied in such computer-executable instructions. Furthermore, the images or other information displayed by an application program module 119 and data processed by the gaze detection system may be stored in one or more data files 121, which may be stored in the memory 104 or any other computer readable medium associated with the computing device 101.

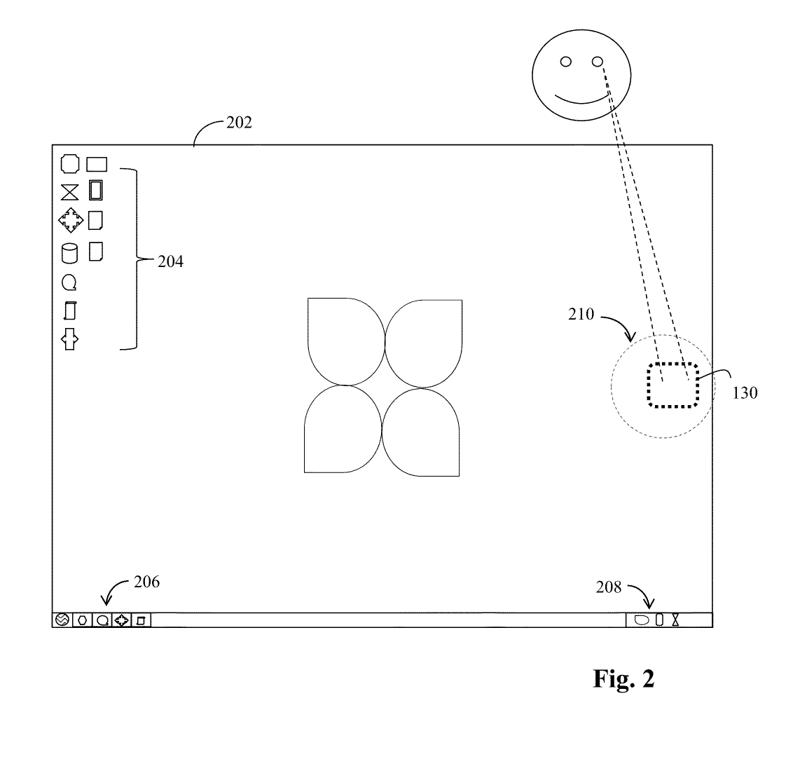

In some embodiments, the gaze detection program module 123 may be configured for determining one or more menu zones and one or more wake zones relative to the display screen 110 or relative to a window or other portion of the display screen 110. A menu zone and/or a wake zone may also or alternatively be defined in locations away from the display screen 110, e.g., below or to the side of the display screen 110. FIG. 2 shows an exemplary user interface 202 displayed by a computing device 101. The user interface 202 displays various content, such as icons 204, menu bar 206 and system tray 208. In some embodiments, a menu zone 210 may be defined relative to one side (or any other position) of the user interface 202. The menu zone 210 can be of any size and may be positioned at any location on (or even away from) the user interface. The menu zone 210 may be of a predefined size and location and/or may be adjustable in size and/or location by the user. The menu zone 210 may be of any suitable geometry (e.g., a point, circle, rectangle, polygon, etc.) and may be defined by coordinates relative to the user interface 202 and/or the display screen 110. In some embodiments, an interface may be provided for allowing the user to adjust the size and/or position of a menu zone 210.

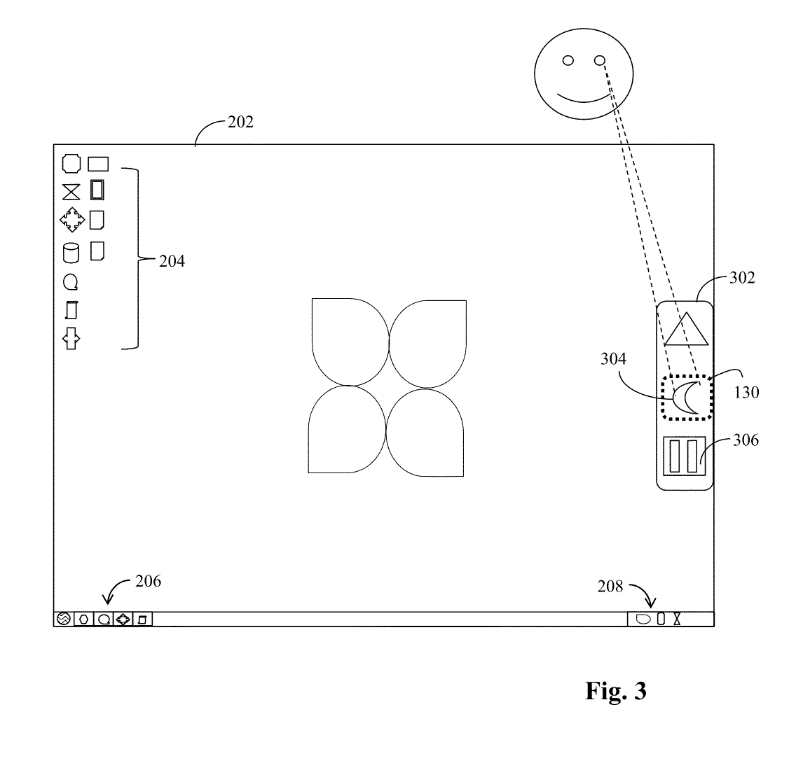

As shown in FIG. 3, the gaze detection program module 123 may be configured for associating a menu 302 with the menu zone 210. When the gaze detection program module 123 detects a gaze point 130 within the menu zone 210, the associated menu may be displayed. The menu 302 may in some cases be displayed over or adjacent to elements already shown on the user interface 202. In the case of displaying the menu 302 adjacent to already displayed elements, some or all elements may need to be resized to allow for the menu 302 to be shown on the user interface 202. When the user looks away from the menu zone 210, the menu 302 may disappear immediately, remain displayed on the user interface 202 indefinitely or disappear after a predetermined amount of time. A gaze point 130 may be recognized as a signal of the user's intent to invoke the menu 302 if the user dwells or fixates on the menu zone 210 a predetermined period of time (e.g., if the gaze point 130 remains in the vicinity of the menu zone 210 until expiration of a threshold amount of time). For example, the threshold time may be defined as a number of seconds or fractions thereof.

The menu 302 may include a selectable stand-by icon 304 for invoking a stand-by mode for the computing device 101. The gaze detection program module 123 may then monitor for a gaze point 130 on or within the vicinity of the selectable stand-by icon 304. When such a gaze point 130 is detected, and assuming a threshold amount of time has expired (if used), the gaze detection program module 123 may invoke the stand-by mode by issuing a stand-by command to the operating system 117 or other program module or process. To assist the user in determining which icon on the menu 302 has been selected, an icon may be changed to a variation, for example a different color, to indicate it has been, or will be, selected.

In some embodiments the menu 302 may also include a selectable pause icon 306 that, when activated, causes the computing device 101 to pause or temporarily disable or deactivate the gaze detection components. This may be used as an added power-saving feature, so that the gaze detection components do not remain active when the computing device 101 is put into stand-by mode. As another example, the user may wish to pause the gaze detection function of the computing device 101 so that it does not undesirable interfere with a particular use of the computing device.

In some embodiments, determining whether a gaze point 130 is within the “vicinity” of an icon, zone or other object to be selected may involve determining whether the gaze point 130 is within a configurable number of inches, centimeters, millimeters or other distance in one or more direction (x,y) from the particular object.

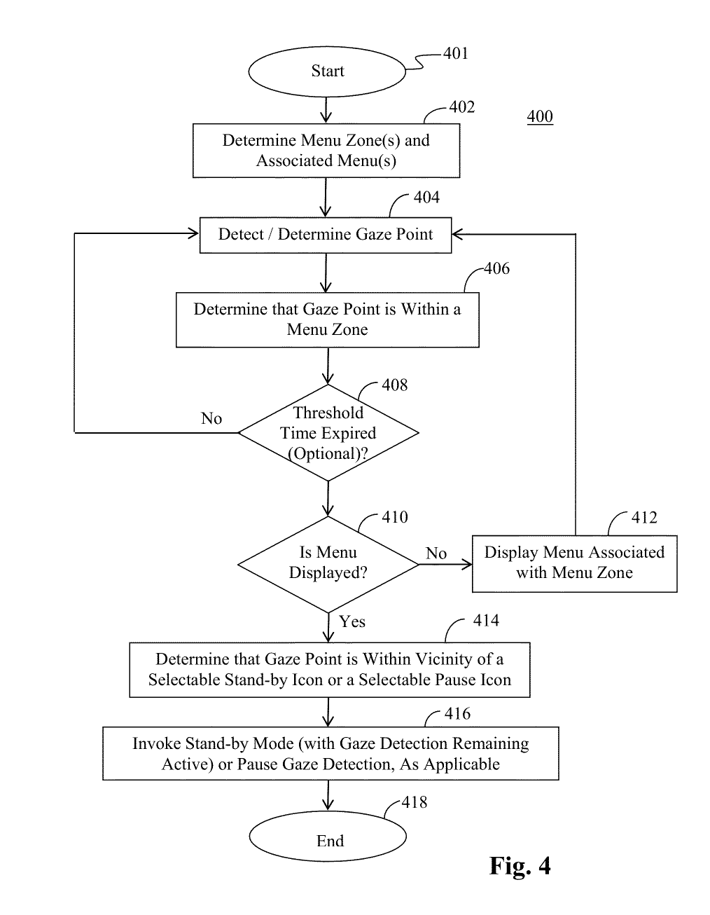

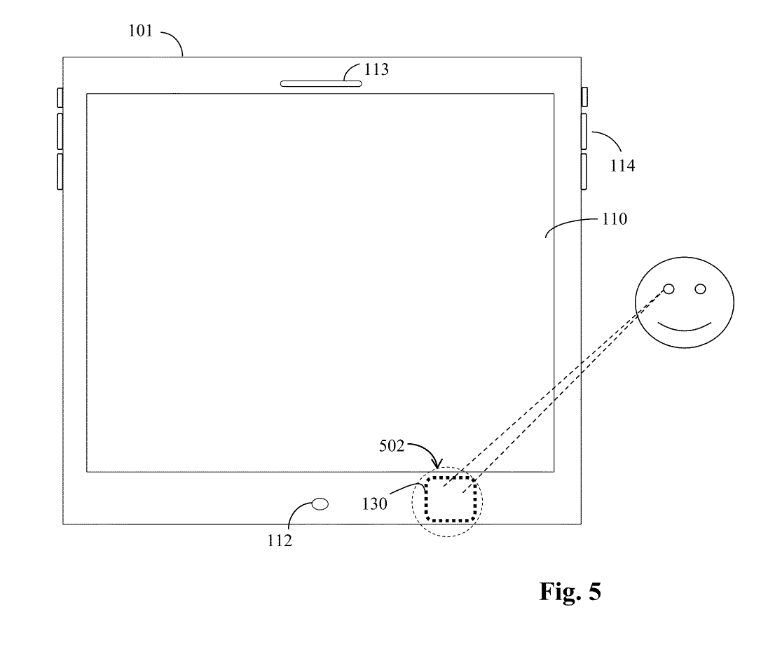

FIG. 4 illustrates an exemplary method for invoking a stand-by mode for a computing device 101 based on gaze detection, according to certain embodiments. The method begins with start step 401, in which the computing device is in an active or “awake” state. From there, the method advances to step 402, where applicable menu zone(s) 210 and associated menu(s) are determined 302. Certain menu zones may be defined for certain application programs or types of application programs, certain window or display screen sizes and/or certain content or types of content. In some embodiments, default or preconfigured menu zones may be used unless a user otherwise defines a menu zone or selects a previously defined menu zone. As described, a menu zone according to certain embodiments may include a selectable stand-by icon 304.

The method next advances to step 404 to detect or determine a gaze point 130 resulting from the user viewing the user interface 202 or some other point relative to the display screen 110. At step 406, the gaze point 130 is determined to be within an applicable menu zone 210 or within a defined position relative to the applicable menu zone 210.

In step 408 a determination may optionally be made as to whether the gaze point 130 remains within the applicable menu zone 210 beyond the expiration of a threshold time period. If the gaze point 130 is determined not to remain with the applicable menu zone 210 beyond expiration of the threshold time period, it may be assumed that the user does not intend to initiate the associated menu 302 and, in that case, the method loops back to step 404 to await detection or determination of the next gaze point 130.

The determination of whether the gaze point 130 remains within the applicable menu zone 210 beyond a threshold time period may involve intelligent filtering. For instance intelligent filtering may involve filtering-out data samples that were not usable for determining a projected gaze position. Additionally the intelligent filtering may involve filtering-out a certain percentage of the gaze data samples that were not usable for determining a projected gaze position due to measurement errors. Preferably the gaze detection system should require that the last sample or a very recent sample of gaze data shows that the user is in fact gazing within the applicable scroll zone as part of this intelligent filtering.

In some embodiments, the gaze detection program module 123 may be configured to differentiate between a user gazing (e.g., for purposes of triggering a scroll action) and a user reading displayed content. For example, known techniques such as detecting and evaluating saccades and whether an eye fixates or dwells on or around a constant point on the display. This information may be used to determine indicators of reading as distinguished from a more fixed gaze. In some embodiments, the gaze detection program module 123 may be configured to use gaze data patterns (e.g., the frequency with which gaze points appear in certain positions) to determine with greater accuracy, based on statistical analysis, when an actual gaze point is within a defined menu zone 210. This approach is particularly useful in connection with relatively small menu zones 210, which may be due to relatively small window and/or display screen 110 sizes.

If the determination of step 408 is performed and the gaze point 130 is determined to remain with the applicable menu zone 210 beyond expiration of the threshold time period, the method advances to step 410 where it is determined whether the applicable menu 302 is already displayed. If not, the method continues to step 412 where the menu 302 is displayed and from there the method loops back to step 404 to await detection or determination of the next gaze point 130. However, if it is determined at step 410 that the applicable menu 302 is already displayed, a determination is then made at step 414 that the gaze point 130 is on or within the vicinity of the selectable stand-by icon 304 or the selectable pause icon 306. If the gaze point 130 indicates selection of the selectable stand-by icon 304, the stand-by mode is invoked at step 416. If the gaze point 130 indicates selection of the selectable pause icon 306, the gaze detection function of the computing device 101 is paused at step 416. Following step 416 the method ends at step 418.

In some embodiments, the computing device 101 may be put into the stand-by mode by way of additional or alternative methods. For example, contact interactions and/or other non-contact user interactions may be used to invoke stand-by mode. In some embodiments, this may involve a contact user interaction or a non-contact user interaction for invoking a menu 302 with a selectable stand-by icon 304, and a contact user interaction or a non-contact user interaction for selecting that icon. In other embodiments, a selectable stand-by icon 304 may be displayed at all times on the user interface 202, thereby eliminating the need to invoke a specialized menu 302. In still other embodiments, stand-by mode may be invoked in traditional ways, such as by way of a physical control (e.g., button or switch, etc.). As is known in the art, the computing device 101 may also be configured to automatically invoke stand-by mode in certain circumstances, such as following a predefined period of non-use or upon detecting that expected battery life has fallen below a predefined threshold, etc.

In some embodiments, the menu 302 may also or alternatively be provided external to the display device 110. In this manner it may be provided on an input device such as an eye tracking component, on the housing of the display device 110 or computing device 101, or on a separate device. The menu 302 may then be comprised of a separate display, or another means of conveying information to a user such as lights (e.g., light emitting diodes), switches or the like. As an alternative the action of choosing an icon 304 on such an external menu 302 may be shown as a transparent image of that icon at an appropriate position on the user interface 202.

In accordance with certain embodiments of the present invention, a computing device 101 may be awoken from stand-by mode based on gaze detection (regardless of how the computing device 101 is placed into stand-by mode). In such embodiments, the computing device 101 may be configured such that the gaze detection components remain active during stand-by mode. In this way, the gaze detection program module 123 may be configured to continuously or intermittently (e.g. once every few seconds or any other defined or configurable time interval) monitor for gaze points 130 within a defined wake zone. In some embodiments, the gaze detection program module 123 may be configured to alter its behavior when the computing device 101 is in stand-by mode. For example, while the gaze detection program module 123 might continuously monitor for gaze points 130 when the computing device 101 is awake, it may be configured to intermittently monitor for gaze points 130 when the computing device 101 is in stand-by mode, which may provide improved power-savings.

As shown in FIG. 5, a wake zone 502 may be defined at a position relative to the display screen 110, for example away from the display screen 110 near the base of the computing device 101 (e.g., in the case of a table computer, mobile phone, or computing devices of like configurations). In embodiments, the wake zone 502 may be defined in the same or an overlapping or adjacent position as the menu zone 210. For example, the wake zone 502 and the menu zone 210 may be defined in the same position away from the display screen 110 near the base of the computing device 101. Accordingly, when a gaze point 130 is detected within the wake zone 502 by the gaze detection program module 123, the gaze detection program module 123 may issue a command to wake the computing device 101 from the stand-by mode. Again, the gaze detection program module 123 may be configured to recognize the gaze point 130 as a signal of the user's intent to wake the computing device 101 if the user dwells or fixates on the wake zone 502 for a predetermined period of time (e.g., if the gaze point 130 remains in the vicinity of the wake zone 502 until expiration of a threshold amount of time).

The wake zone 502 can be of any size and may be positioned at any location on (or even away from) the user interface. The wake zone 502 may be of a predefined size and location and/or may be adjustable in size and/or location by the user. The wake zone 502 may be of any suitable geometry (e.g., a point, circle, rectangle, polygon, etc.) and may be defined by coordinates relative to the user interface 202 and/or the display screen 110. In some embodiments, an interface may be provided for allowing the user to adjust the size and/or position of the wake zone 502.

The wake on gaze functionality of the present in invention may, in some embodiments, be implemented in conjunction with some type of user identification function to ensure that the person intending to wake the computing device 101 is authorized to do so. This user identification function could be accomplished by way of an iris or face recognition feature. This function could also be implemented by requiring a predetermined eye gesture or sequence of eye gestures to be detected by the gaze detection program module 123. For example, the user may be required to follow a marker over the user interface 202 or to blink or otherwise move his or her eyes in a given sequence or pattern. In other embodiments, this user identification function could be implemented by requiring the user to speak a username and/or password (which could be authenticated based on a match to a pre-stored username and/or password and/or based on a match of voice pattern, etc.), or to input some other biometric (e.g., fingerprint, etc.) in response to the gaze detection program module 123 detecting the user's intent to wake the computing device 101

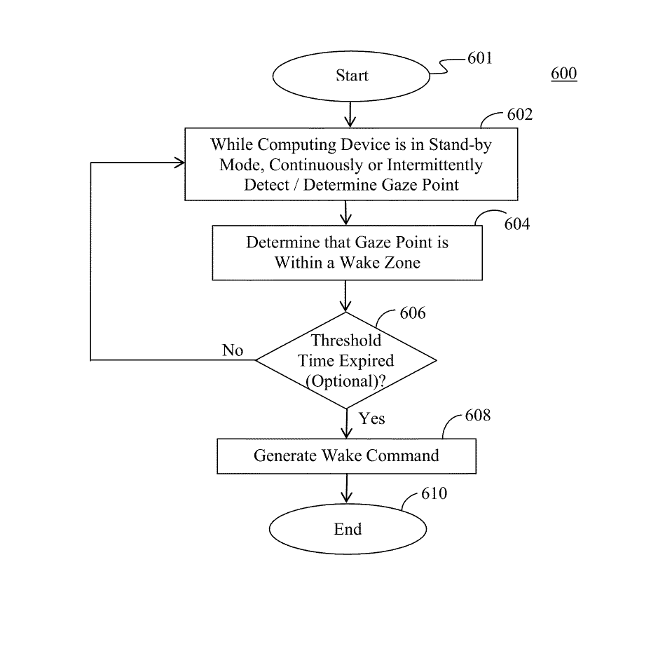

FIG. 6 illustrates an exemplary method for waking a computing device 101 from stand-by mode based on gaze detection, according to certain embodiments. The method begins with start step 601, in which the computing device is in a stand-by mode as described herein. From there, the method advances to step 602, to continuously or intermittently monitor for, detect and determine gaze points 130. When a gaze point 130 is detected, the method advances to step 404 where the gaze point 130 is determined to be within the wake zone 502 or within a defined position relative to the wake zone 502.

In step 606 a determination may optionally be made as to whether the gaze point 130 remains within the wake zone 502 beyond the expiration of a threshold time period. If the gaze point 130 is determined not to remain with the wake zone 502 beyond expiration of the threshold time period, it may be assumed that the user does not intend to wake the computing device 101 from stand-by mode and, in that case, the method loops back to step 602 to await detection or determination of the next gaze point 130.

The determination of whether the gaze point 130 remains within the wake zone 502 beyond a threshold time period may involve intelligent filtering. For instance intelligent filtering may involve filtering-out data samples that were not usable for determining a projected gaze position. Additionally the intelligent filtering may involve filtering-out a certain percentage of the gaze data samples that were not usable for determining a projected gaze position due to measurement errors. Preferably the gaze detection system should require that the last sample or a very recent sample of gaze data shows that the user is in fact gazing within the applicable scroll zone as part of this intelligent filtering.

If the determination of step 606 is performed and the gaze point 130 is determined to remain with the wake zone 502 beyond expiration of the threshold time period, the method advances to step 608 where a command is generated to wake the computing device 101 from the stand-by mode. As described, such a command may be passed to the operating system 117 or another program module or process configured from waking the computing device 101 from stand-by mode. Following step 608, the method ends at step 610.

In some embodiments, other zones may be defined relative to the user interface 202 and/or display device 110 for implementing other power-saving functions. For example, a “dim” zone may be defined such that when a gaze point 130 is detected therein the brightness of the display device may be increased or decreased in either an analog or digital fashion. As another example, a “battery mode” zone may be defined such that when a gaze point 130 is detected therein changes may be made to the different battery usage configuration of the computing device. These and other power-saving functions will be apparent to those of ordinary skill in the art and are deemed to be within the scope of the present invention.

Although the methods described herein for invoking and waking a computing device from stand-by mode based on gaze detection may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowcharts of FIGS. 4 and 6 may show certain functionality and operations described as performed by the gaze detection program module 123 or the DSP unit 105 described by way of example herein. If embodied in software, each box in the flowcharts may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block in the flowchart may represent a circuit or a number of interconnected circuits to implement the specified logical function(s).

Although the flowcharts of FIGS. 4 and 6 show a specific order of execution, it is understood that the order of execution may differ from that which is depicted. For example, the order of execution of two or more steps may be scrambled relative to the order shown. Also, two or more blocks shown in succession in either FIG. 4 or FIG. 6 may be executed concurrently or with partial concurrence. Further, in some embodiments, one or more of the steps shown in either of the flowcharts may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Any logic or application described herein, including the gaze detection program module 123, application program module 119 and other processes and modules running on a computing device 101, that comprises software or code can be embodied in any non-transitory computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A computing device configured for waking from a stand-by mode in response to gaze detection, comprising:
a display device;
a memory for storing a program module for placing the computing device into a stand-by mode and for waking the computing device from the stand-by mode in response to a wake command;
gaze detection components for detecting a gaze point relative to the display device, wherein the gaze detection components remain active when the computing device is in the stand-by mode; and
a processor communicatively coupled to the memory for executing the program module and for controlling operations of the gaze detection components;
wherein the operations of the gaze detection components include:
determining at least one wake zone relative to the display device,
when the computing device is in the stand-by mode, detecting the gaze point, and
in response to determining that the gaze point is within the wake zone, generating the wake command and passing the wake command to the program module to cause the program module to wake the computing device from the stand-by mode.

2. The computing device as recited in claim 1, wherein the wake zone is positioned below the display device.

3. The computing device as recited in claim 1, wherein the program module places the computing device into the stand-by mode following a period of inactivity.

4. The computing device as recited in claim 1, wherein the program module places the computing device into the stand-by mode in response to a stand-by command; and
wherein the operations of the gaze detection components further include, when the computing device is not in the stand-by mode, detecting another gaze point and, in response to determining that the other gaze point is within the vicinity of a selectable stand-by icon, generating the stand-by command and passing the stand-by command to the program module to cause the program module to place the computing device into the stand-by mode.

5. The computing device as recited in claim 1, wherein the program module places the computing device into the stand-by mode in response to a stand-by command; and
wherein the operations of the gaze detection components further include:
determining at least one menu zone relative to the display device,
when the computing device is not in the stand-by mode, detecting another gaze point,
in response to determining that the other gaze point is within the menu zone, displaying a menu that includes a selectable stand-by icon,
in response to determining that a second gaze point is within the vicinity of the selectable stand-by icon, generating the stand-by command and passing the stand-by command to the program module to cause the program module to place the computing device into the stand-by mode.

6. The computing device as recited in claim 5, wherein the wake zone and the menu zone are defined as being in the same position below the display device.

7. The computing device as recited in claim 1, wherein a position of the wake zone relative to the display screen is configurable by a user of the computing device.

8. The computing device as recited in claim 1, wherein the gaze detection components comprise a camera, at least one illuminator in proximity to the camera and a gaze detection program module, wherein the gaze detection program module is stored in the memory and comprises instructions for performing the operations of the gaze detection components.

9. The computing device as recited in claim 1, wherein the program module comprises an operating system of the computing device.

10. A computer-implemented method for waking a computing device from a stand-by mode in response to gaze detection, comprising:
determining at least one wake zone relative to a display device of the computing device;
when the computing device is in the stand-by mode, detecting a gaze point relative to the display device;
in response to determining that the gaze point is within the wake zone, generating a wake command and passing the wake command to a program module to cause the program module to wake the computing device from the stand-by mode.

11. The computer-implemented method as recited in claim 10, wherein the program module comprises an operating system of the computing device.

12. The computer-implemented method as recited in claim 10, wherein the program module places the computing device into the stand-by mode following a period of inactivity.

13. The computer-implemented method as recited in claim 10, wherein the program module places the computing device into the stand-by mode in response to a stand-by command; and
wherein the method further comprises:
when the computing device is not in the stand-by mode, detecting another gaze point and, in response to determining that the other gaze point is within the vicinity of a selectable stand-by icon, generating the stand-by command and passing the stand-by command to the program module to cause the program module to place the computing device into the stand-by mode.

14. The computer-implemented method as recited in claim 10, wherein the program module places the computing device into the stand-by mode in response to a stand-by command; and
wherein the method further comprises:
determining at least one menu zone relative to the display device,
when the computing device is not in the stand-by mode, detecting another gaze point,
in response to determining that the other gaze point is within the menu zone, displaying a menu that includes a selectable stand-by icon,
in response to determining that a second gaze point is within the vicinity of the selectable stand-by icon, generating the stand-by command and passing the stand-by command to the program module to cause the program module to place the computing device into the stand-by mode.

15. The computer-implemented method as recited in claim 14, wherein the wake zone and the menu zone are defined as being in the same position below the display device.

16. The computer-implemented method as recited in claim 10, further comprising defining a position of the wake zone relative to the display screen in response to user input.

17. A non-transitory computer readable storage medium having instructions stored thereon that, when retrieved and executed by a computing device, cause the computing device to perform operations for waking the computing device from a stand-by mode in response to gaze detection, the operations comprising:
determining at least one wake zone relative to a display device of the computing device;
when the computing device is in the stand-by mode, detecting a gaze point relative to the display device;
in response to determining that the gaze point is within the wake zone, generating a wake command and passing the wake command to a program module to cause the program module to wake the computing device from the stand-by mode.

18. The non-transitory computer readable storage medium as recited in claim 17, wherein the program module places the computing device into the stand-by mode in response to a stand-by command; and
wherein the operations further comprise:
when the computing device is not in the stand-by mode, detecting another gaze point and, in response to determining that the other gaze point is within the vicinity of a selectable stand-by icon, generating the stand-by command and passing the stand-by command to the program module to cause the program module to place the computing device into the stand-by mode.

19. The non-transitory computer readable storage medium as recited in claim 17, wherein the program module places the computing device into the stand-by mode in response to a stand-by command; and
wherein the operations further comprise:
determining at least one menu zone relative to the display device,
when the computing device is not in the stand-by mode, detecting another gaze point,
in response to determining that the other gaze point is within the menu zone, displaying a menu that includes a selectable stand-by icon,
in response to determining that a second gaze point is within the vicinity of the selectable stand-by icon, generating the stand-by command and passing the stand-by command to the program module to cause the program module to place the computing device into the stand-by mode.

20. The non-transitory computer readable storage medium as recited in claim 17, wherein the operations further comprise defining a position of the wake zone relative to the display screen in response to user input.
